(19) United States
(12) Patent Application Publication
(10) Pub. No.: US 2011/0133878 A1
(43) Pub. Date: Jun. 9, 2011

(54) Stacked differential inductor

(76) Inventors: Tzuyin CHIU, Pudong (CN); Xiangming Xu, Shanghai (CN); Miao Cai, Pudong (CN)

(21) Appl. No.: 12/960,166

(22) Filed: Dec. 3, 2010

(30) Foreign Application Priority Data
Dec. 8, 2009 (CN) 200910201901.6

(51) Int. Cl. H01F 5/00

(52) U.S. Cl. 336/200

(57) ABSTRACT

A structure of stack differential inductor is represented in this invention; this structure includes top and bottom metal traces, which are aligned with each other and symmetric. Starting from one port and after half turn, the top metal trace is connected to bottom metal trace through via holes. Meanwhile, after another half turn, the bottom trace is connected to top trace through via holes. The inductance is increased by means of this method. With the same chip area, this stack differential inductor possesses larger inductance and higher Q factor because of the larger mutual inductance between top and bottom metal than conventional differential inductor.

The current invention claims a foreign priority to the China application number 200910201901.6 filed on Dec. 8, 2009.

### FIELD OF THE INVENTION

The invention is related to microelectronics, and more particularly to realizing high inductance on-chip stacked differential inductor for RF application.

### BACKGROUND OF THE INVENTION

In present, there are a lot of passive devices in the integrated circuits. One of the most important components in RF CMOS/BiCMOS integrated circuits is on-chip inductor. Inductor has great impact on the RF characteristic in common wireless product. The design and analysis for this component has been widely studied as a result. Nowadays, the high Q factor (quality factor) on-chip inductor has been widely used in voltage controlled oscillator, low noise amplifier and other RF building blocks. On-chip stack inductor reduced chip area in a large extent, which reduced the production cost.

Q factor is the major specification of the inductor, high Q means low loss and high efficiency. Q factor is derived by:

$$Q \approx \frac{wL}{{R}_{s}} \qquad Equation 1$$

Q is quality factor, w is frequency, L is inductance under a certain frequency, Rs is resistance under a certain frequency.

As shown in FIG. 1, the conventional differential inductor is formed with single metal layers. With the same inductance, the differential inductor have higher Q factor compare to single ended inductor. In order to realize higher inductance, the chip should be larger. So a new structure of differential inductor which can realize both higher inductance and Q factor is needed.

### SUMMARY OF THE INVENTION

This invention provides a stacked differential inductor, which possesses larger inductance and higher Q factor than conventional differential inductor with the same chip area.

This stacked differential inductor has a structure with multi layers, comprises symmetric top and bottom metal traces, which is aligned with each other. Starting from one inductor port, after half turn, the top metal trace is connected to bottom metal trace through via holes, and after another half turn, the bottom trace is connected to top trace through via holes, and the center tap connect the top and the bottom metal traces at half point of the metal traces.

The advantage of this invention is: with the same chip area, this stack differential inductor possesses larger inductance and higher Q factor than conventional differential inductor because of the mutual inductance between top and bottom metal.

### BRIEF DESCRIPTION OF THE DRAWINGS

These and other features of this invention will be more readily understood from the following detailed description of the invention in conjunction with the accompanying drawings in which:

FIG. 1 is the top-view diagram of conventional differential inductor

FIG. 2 is the top-view diagram of differential inductor in this invention;

FIG. 3 is the stereogram of differential inductor in this invention;

### DETAILED DESCRIPTION OF THE INVENTION

This stacked differential inductor has a structure with multi layers, comprising: the top and bottom metal trace, which are symmetric; Starting from one port, after half turn the top metal trace is connected to bottom metal trace through via holes, and after another half turn, the bottom trace are connected to top trace through via holes.

More detailed, the layout of stacked differential inductor with metal trace aligned with each other is shown as FIG. 2 and stereogram in FIG. 3 (taking two metal layers with equal thickness, 3 turns, octagonal stack differential inductor as example). The thicknesses of these two metal layers are equal, which are aligned with each other. The inductor starts from one port, after half turn the top metal trace is connected to bottom metal trace through via holes, and after another half turn, the bottom trace are connected to top trace through via holes, and the center tap connect the top and the bottom metal traces at half point of the metal traces.

With this structure, the mutual inductance of top and bottom metal trace which are symmetric and with same width achieves a higher inductance without any additional effect on Q factor.

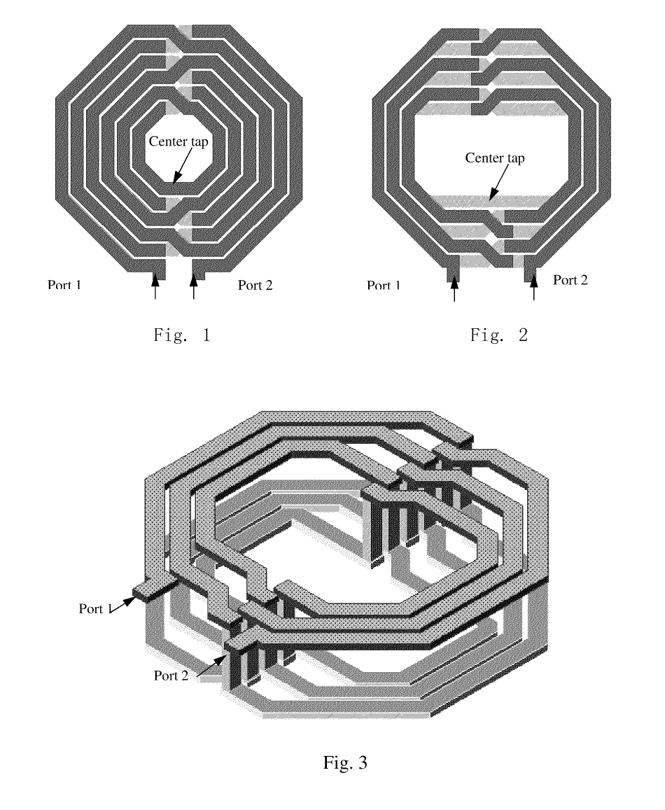

The simulation results of conventional differential inductor as FIG. 1 is: L=3.436pH and Q=7.81. While the new stacked differential inductor with same size is L=5.47pH and Q=8.06. The result shows the new structure inductor improves the L in a large extent and keeps higher Q factor.

In the example, the width and thickness of top and bottom metal trace are equal, with this structure, the mutual inductance of the top and bottom metal trace efficiently used(the metal trace are all overlapped).With same thick metal can reduce the resistance and thus high Q factor can be realized. While the structure can also be used in general RFIC process (only thick top metal) and the metal width is not limited to be equal.

The new structure of this invention can be realized with equal or unequal metal thickness and width, the metal layers are not limited to 2, and the turns could be 3 or others. The shape of the stack differential inductor is not limited to octagon.

The new structure of this invention is not limited to 2 metal layers. This invention is preferentially applied to the top metal layer and top minus one layer. However, other layers are also suitable for use.

While the invention has been particularly shown and described with reference to the preferred embodiments thereof, it will be understood by those skilled in the art that various changes in form and details may be made without departing from the spirit of the invention or from the scope of the appended claims.

1. A stacked differential inductor formed with multi layers comprises:
a top metal trace;
a bottom metal trace;
the top and bottom metal traces are symmetric;
two ports being disposed on the top metal trace,
the top metal trace being connected to the bottom metal trace after half turn through via holes; and
the bottom metal trace being connected to the top metal trace after half turn through via holes;

2. The stacked differential inductor of claim 1 comprises: a center tap connecting the top and the bottom metal traces at the half of the metal traces.

3. The stacked differential inductor of claim 1 comprises: the width of the top metal trace and the width of the bottom metal trace are equal.

4. The stacked differential inductor of claim 1 comprises: the thicknesses of the top metal trace and the thickness of the bottom metal trace are equal.

5. The stacked differential inductor of claim 1 comprises: each of the metal traces being formed with two metal layers.

6. The stacked differential inductor of claim 1 comprises: the quantity of turns of each of the metal traces is equal or greater than one turn.

7. The stacked differential inductor of claim 1 comprises: the shape of the metal trace is selected from the group consisting of octagon, rectangle or circle.
